(19) United States
(12) Patent Application Publication
(10) Pub. No.: US 2008/0169032 A1
(43) Pub. Date: Jul. 17, 2008

(54) Sanitary Water Outlet Fitting Comprising at Least One Water Outlet Pipe

(75) Inventor: Lars Schmid, Nuertingen (DE)

Correspondence Address: FACTOR & LAKE, LTD, 1327 W. WASHINGTON BLVD., SUITE 5G/H, CHICAGO, IL, 60607, US

(73) Assignee: HANSA METALLWERKE AG, Stuttgart (DE)

(21) Appl. No.: 11/793,319

(22) PCT Filed: Dec. 13, 2005
(86) PCT No.: PCT/EP05/13354

§ 371 Date: Feb. 12, 2008

(30) Foreign Application Priority Data
Dec. 20, 2004 (DE) 10 2004 061 225.0

(51) Int. Cl. B05B 1/14

(52) U.S. Cl. 137/561 A

(57) ABSTRACT

The invention relates to a sanitary water outlet fitting (1) which comprises at least one water outlet pipe (3) with a water channel (12) extending therein and having a water outlet device with a water outlet opening. Said water outlet pipe (3) comprises at least one additional separate water channel (13) having at least one additional water outlet device that is axially off-set in relation to the first water outlet opening. Every water channel (12, 13) is linked with the corresponding water outlet device via a cross-duct.

The present invention relates to a sanitary water outlet fitting comprising at least one water outlet pipe with a water channel extending therein and having a water outlet device with a water outlet opening.

In known sanitary water outlet fittings of this type the water outlet pipe comprises a single water channel with a single water outlet opening, so that only one water jet at a predeterminable water temperature and a predeterminable water flow can be realised.

The object of the present invention is to design a sanitary water outlet fitting of the type mentioned in the introduction, so that a plurality of independently adjustable water jets, in particular having different temperatures and/or water flow amounts, can be generated in a technically simple manner with the smallest possible expenditure on material.

This object is achieved according to the invention by the fact that the water outlet pipe comprises at least one further separate water channel with at least one further water outlet device that is axially off-set in relation to the first water outlet opening, in which each water channel is connected via a cross-duct to the water outlet device corresponding to it.

According to the invention a plurality of water outlet devices with water openings is thus provided, which are supplied separately with water via a respective water channel. The water channels may be connected in each case via their own supply channel in a fitting housing to one or more mixing valves or the like, through which water of the desired flow amount and temperature is provided. The water channel itself may run substantially parallel to the axis of the water outlet pipe. The cross-duct on the other hand runs substantially perpendicular to the axis of the water outlet pipe. The water channel as well as the cross-duct may accordingly be realised in a technically simple manner, for example by a respective bore.

An advantageous embodiment envisages that the cross-ducts run rectilinearly, in particular perpendicular to the jacket surface of the water outlet pipe. In this way all water channels can be reached with only one, in particular drilled, cross-duct.

Conveniently the order in which the water channels are arranged, seen from the water outlet opening, corresponds to the order of the water outlet openings respectively corresponding to them, seen from the fitting housing. This has the advantage that water channels of water outlet openings more remote from the fitting housing are not touched by the cross-ducts of closer water outlet openings.

In order that each cross-duct simply joins up to the water channel corresponding to it, a further advantageous embodiment envisages that the water channels, seen from the fitting housing, terminate in each case directly behind the cross-ducts corresponding to them. In this way no diversions that bypass the cross-ducts are necessary.

A water outlet pipe that advantageously has over its whole length a constant, in particular circular, cross-section is technically simple to manufacture.

The water channels may advantageously in each case have a constant cross-section over their whole length, so that they can for example be drilled in a technically simple manner, or in the case in particular of water outlet pipes cast at least in part of plastics material can be recessed in the casting process, so that separate pipes or lines can be dispensed with.

In order to save space, the water channels preferably run substantially parallel.

A further advantageous embodiment envisages that the water channels in each case comprise a water-conveying main region of large cross-section and a water-conveying connection region connected to the latter, for the corresponding water outlet devices, which connection region extends beyond the axial plane containing the axis of the corresponding cross-duct. In this way the cross-section of the water outlet pipe can be optimally utilised since the water-conveying main regions can be distributed as far as possible over the whole cross-section, in particular laterally of the connection regions.

In order to achieve cross-sectional surfaces as large as possible for the main regions, it is advantageous in particular in the case of a water outlet pipe of circular cross-section to arrange the main regions of the water channels substantially along the edge of the water outlet pipe.

In order to realise a water curtain from the individual water jets, a further advantageous embodiment envisages that the water outlet openings are arranged along a straight line that runs in particular parallel to the axis of the water outlet pipe.

In order to keep the manufacturing costs low, the water outlet pipe advantageously has an outer pipe and a cylindrical insert which can be inserted into the latter, in which the water channels extend. The outer pipe may be manufactured from an optically attractive and stable material, for example from metal. The cylindrical insert may be manufactured from an easily machinable and workable, in particular corrosion-resistant material, preferably plastics. The water outlet devices may thus also be already pre-mounted in the cylindrical insert and then inserted into the outer pipe. The cylindrical insert and the water outlet pipe may also have a round, oval or polygonal, in particular rectangular or hexagonal, cross-section.

An adjustable water nozzle, with which the water jet can be directed, is possible if advantageously the water outlet devices in the cylindrical insert in each case comprise a receptacle, connected to the respective water channel, for a body that can be inwardly displaced in particular perpendicular to the jacket surface of the cylindrical insert, in particular for a rotatable sphere or a cylindrical piece, and the body comprises a through channel, in which the receptacle comprises a pre-tensioning unit, in particular an elastic O-ring or an elastic disk or the like, which forces the body outwardly. When the cylindrical insert is inserted into the outer pipe the body can thus be displaced inwardly. In the end position of the cylindrical insert the bodies are forced into the corresponding water outlet openings in the outer pipe.

In addition to this a centring cylinder for the body may be provided, with which the body is held in situ during the insertion of the cylindrical insert into the outer pipe. If the body is a sphere, this prevents the sphere from rotating, so that the channel, in this case a spherical channel, can no longer be reached from the water outlet opening.

A further advantageous embodiment envisages that a plurality of adjacent water outlet openings are associated with at least one water channel, by means of which openings a larger region can be supplied with water of uniform temperature and flow volume.

It is particularly convenient in this respect if a group of water outlet openings arranged behind one another when viewed in the flow direction is associated with at least one water channel, and the water channel terminates immediately behind the last water outlet opening of the group viewed in the flow direction, so that the water channels of other water outlet devices are not touched by the corresponding cross-ducts.

In a further advantageous embodiment the water outlet pipe can be connected to the fitting housing in a technically particularly simple and rapid manner, in which embodiment the ends of the water channels project from the end of the water outlet pipe facing towards the fitting housing, their axes being oriented in this case parallel to the axis of the water outlet pipe, and the fitting housing comprises a socket chamber with socket receptacles complementary to the ends of the water channels.

In order to fix and seal the connection in a space-saving manner, the water outlet pipe may advantageously be cast in the socket chamber from hardenable material.

One embodiment of the invention is described in more detail hereinafter with the aid of the drawings, in which:

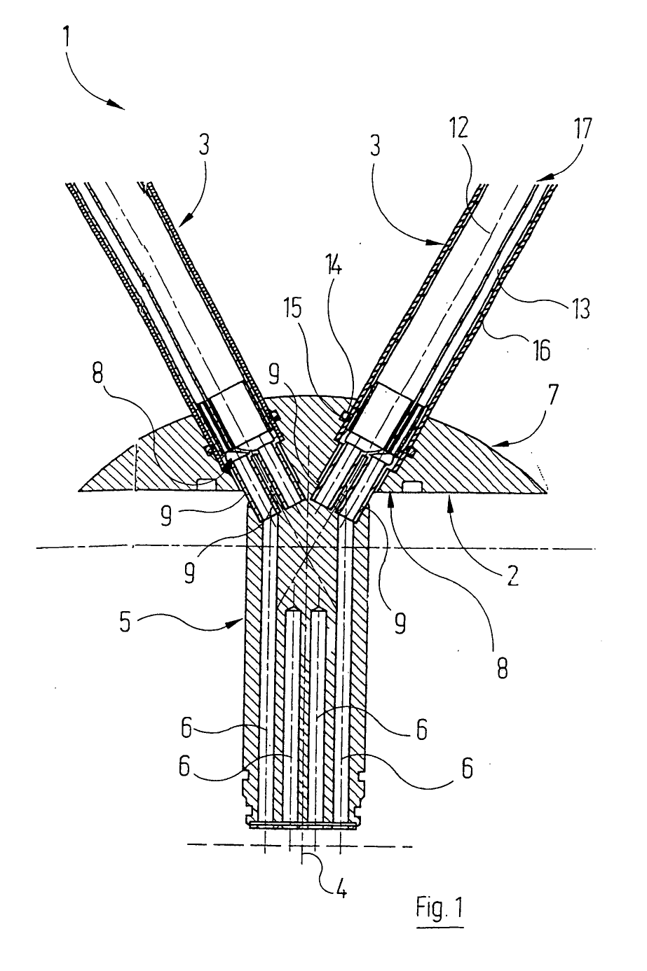

FIG. 1 shows diagrammatically a vertical section of a sanitary water outlet fitting comprising two water outlet pipes, of which in each case simply the lower end is illustrated;

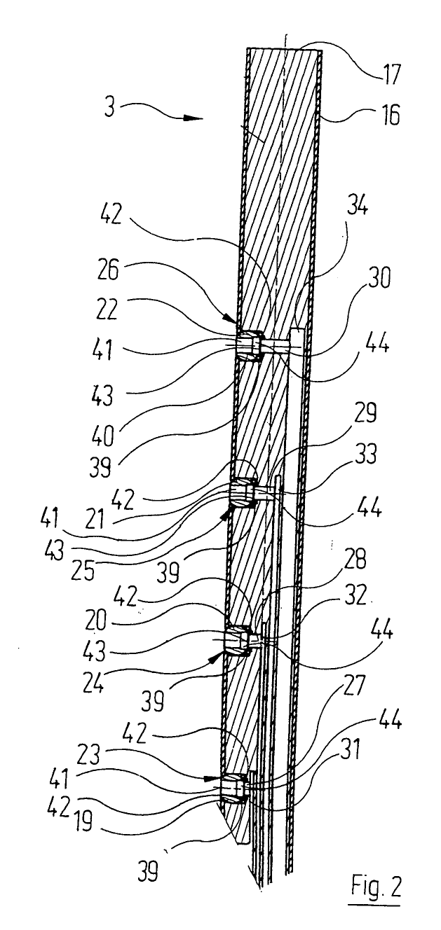

FIG. 2 shows diagrammatically the upper region of the water outlet pipe illustrated on the right-hand side of FIG. 1, comprising four water outlet devices;

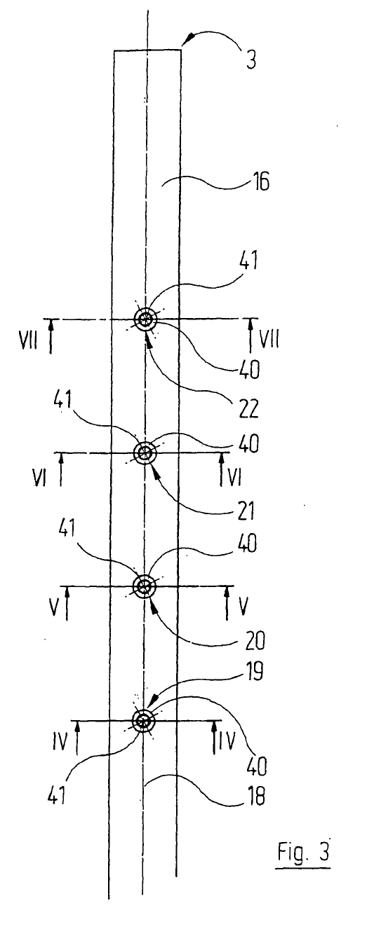

FIG. 3 shows diagrammatically a left-hand side view of the water outlet pipe illustrated in FIG. 2;

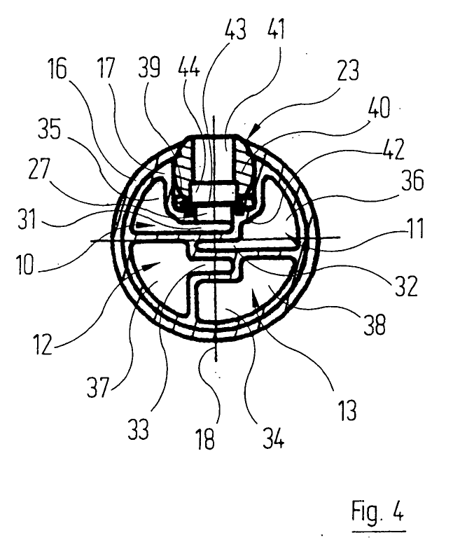

FIG. 4 shows diagrammatically a section of the water outlet pipe illustrated in FIG. 3, in the region of a first water outlet device along the line IV-IV shown there;

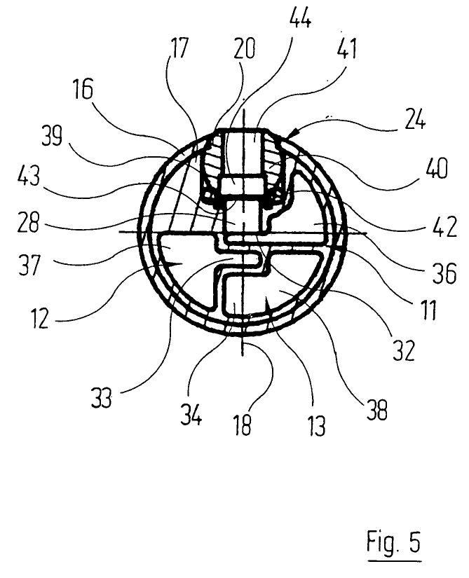

FIG. 5 shows diagrammatically a section of the water outlet pipe illustrated in FIG. 3, in the region of a second water outlet device along the line V-V shown there;

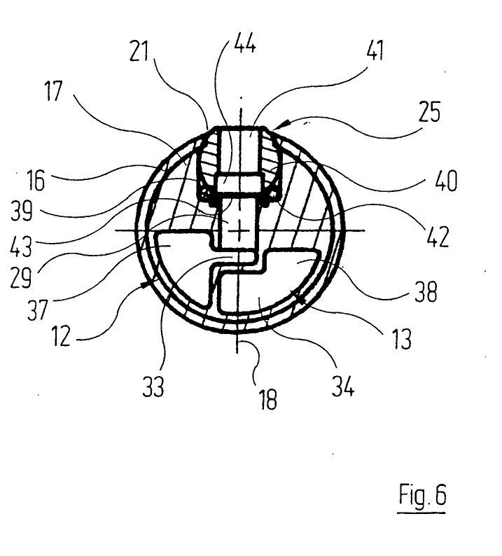

FIG. 6 shows diagrammatically a section of the water outlet pipe illustrated in FIG. 3, in the region of a third water outlet device along the line VI-VI shown there;

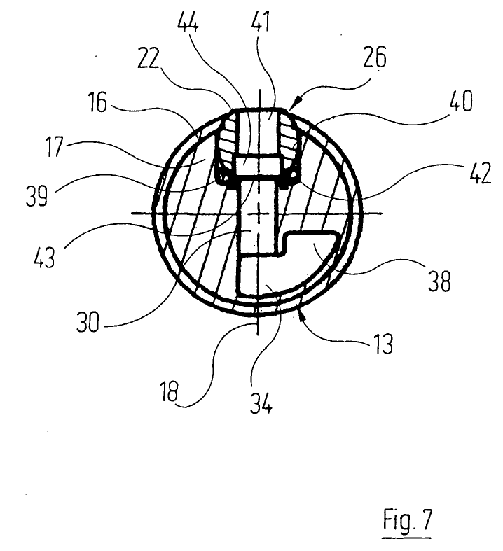

FIG. 7 shows diagrammatically a section of the water outlet pipe illustrated in FIG. 3, in the region of a fourth water outlet device along the line VII-VII shown there;

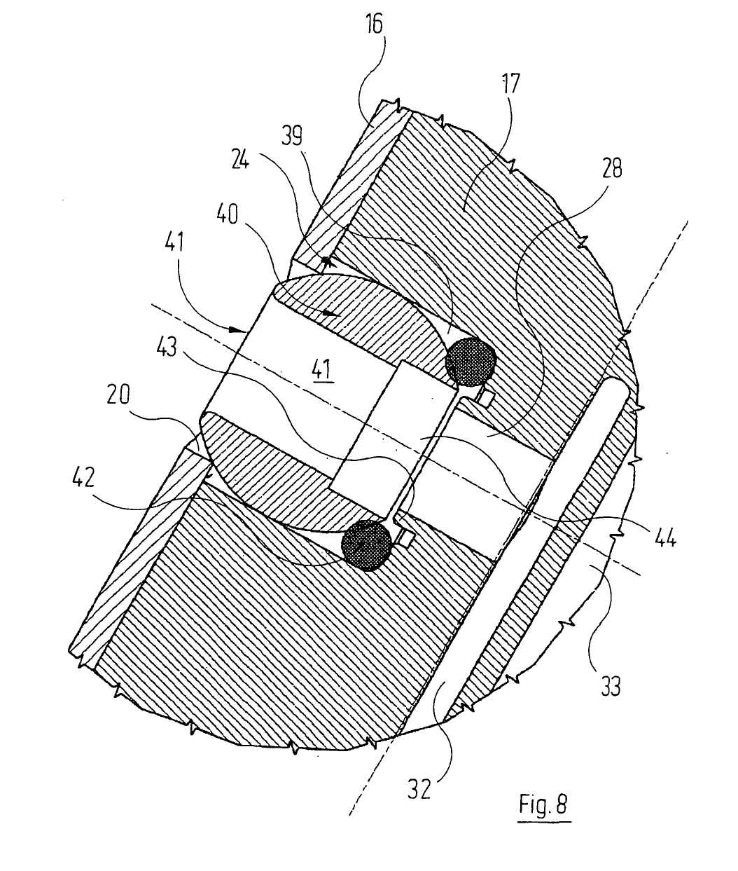

FIG. 8 shows diagrammatically a detailed view in the region of the second water outlet device illustrated in FIG. 2.

FIG. 1 shows a vertical section of a sanitary water outlet fitting 1 with a fitting housing 2 and two water outlet pipes 3 exiting at an angle.

The water outlet fitting 1 is designed to be mirror symmetrical to a virtual vertical plane 4 perpendicular to the plane of the page, the two water outlet pipes 3 otherwise being of identical design and construction.

The fitting housing 2 comprises, as shown at the foot of FIG. 1, a cylindrical securement shank 5, with which it is fixed in a known manner to a wash-hand basin (not shown). In the securement shank 5 extend eight separate supply channels 6 for the water outlet pipes 3, of which only four are visible in FIG. 1, from separately adjustable mixing valves (not shown) parallel to the axis of the securement shank 5 in the upward direction.

The securement shank 5 extends in FIG. 1 upwardly into a screen-shaped receptacle unit 7 for the two water outlet pipes 3. The receptacle unit 7 has for example a substantially flat lower surface and, seen from above, a convex upper surface.

Two substantially identical socket chambers 8 in the form of substantially circular-cylindrical openings for the water outlet pipes 3 are arranged in the upper surface of the receptacle unit 7, to the right and left of the vertical plane 4 in FIG. 1. The axes of the socket chambers 8 are in each case inclined at an angle of about 30° with respect to the vertical plane 4.

Each socket chamber 8 has four socket receptacles 9 in the form of cylindrical bores, only two of which are visible in FIG. 1. Into each socket receptacle 9 is inserted a complementary end of a first, second, third and fourth water channel 10, 11, 12, 13 of the respective water outlet pipe 3 (see FIG. 4), of which in FIG. 1 only the third and fourth water channels 12, 13 are visible. The axes of the socket receptacles 9 run parallel to the axis of the respective socket chamber 8. Each socket receptacle 9 is connected to a corresponding supply channel 6.

The two water outlet pipes 3 have a substantially constant circular external cross-section over their whole length, which corresponds to the internal cross-section of the upper region of the socket chambers 8. The water outlet pipe 3 is sealed against the socket chamber 8 in each case with a O-ring 15, which lies in a groove 14 of the jacket surface of the socket chamber 8. In addition the socket chambers 8 are cast from a hardenable material, so that the water outlet pipes 3 are fixed in a space-saving manner and without additional structural parts, and the water channels 10, 11, 12 and 13 are sealed against the respective socket receptacle 9. Instead of casting the socket chambers 8, these may, provided that sufficient installation space is available, also be sealed in a conventional manner, for example with O-rings, against the water outlet pipes 3.

The upper region of the right-hand water outlet pipe 3, not shown in FIG. 1, is illustrated in a sectional view in FIG. 2. A left-hand side view of this water outlet pipe 3 is shown in FIG. 3. Since the left-hand water outlet pipe 3 and the right-hand water outlet pipe 3 are constructed symmetrically and are otherwise identical, a separate description of the former will be dispensed with hereinafter.

The water outlet pipe 3 comprises a hollow cylindrical outer pipe 16 and a cylindrical insert 17 complementary thereto.

In FIG. 3, a first, second, third and fourth water outlet opening 19, 20, 21 and 22 are provided in the jacket of the outer pipe 16, from the bottom upwardly along a sectional straight line of the jacket with a plane 18 running vertically and perpendicular to the plane of the page in FIG. 3. In FIG. 2 a corresponding first, second, third and fourth water outlet device 23, 24, 25 and 26 are arranged in the cylindrical insert 17, to the right of the water outlet openings 19, 20, 21, 22.

A corresponding first, second, third and fourth cross-duct 27, 28, 29, 30, all of which have identical cross-sections but are successively of increasing length, lead from the first, second, third and fourth water outlet device 23, 24, 25, 26 in FIG. 2 horizontally towards the right, to a first, second, third and fourth connection region 31, 32, 33, 34. The connection regions 31, 32, 33, 34 are constituent parts of the first, second, third and fourth water channels 10, 11, 12, 13. The axes of the cross-ducts 27, 28, 29, 30 run in the plane 18 radially in the cylindrical insert 17.

The connection regions 31, 32, 33, 34 are in FIG. 2 arranged to the right of the water outlet devices 23, 24, 25, 26, from left to right, and in FIGS. 4, 5, 6, 7 are arranged under these, from the top downwards, in the same order as the water outlet devices 23, 24, 25, 26 corresponding to them are arranged from the bottom upwards in FIGS. 1 and 2. The connection regions extend in each case beyond the plane 18 and the axial plane aligned perpendicular thereto.

The water channels 10, 11, 12, 13 have in each case a constant cross-section over their whole length. Their axes run parallel to the axis of the connection pipe 3. The water channels in each case terminate just above the water outlet device 23, 24, 25, 26 corresponding to them.

The second water outlet device 24 is illustrated in detail in FIG. 8.

Each connection region 31, 32, 33, 34 transforms over the whole length of the corresponding water channel 10, 11, 12, 13 into a first, second, third and fourth main region 35, 36, 37, 38 of the water channels 10, 11, 12, 13, as shown in a sectional view in FIGS. 4, 5, 6 and 7. In this way it is possible for each cross-duct 27, 28, 29, 30 to open into only one connection region 31, 32, 33, 34 of a water channel 10, 11, 12, 13.

The water outlet devices 23, 24, 25, 26 are of identical design and construction. They have in each case a stepped bore in the jacket surface of the cylindrical insert 17 facing towards the respective water outlet opening 19, 20, 21, 22, their region 39 of larger diameter serving as spherical receptacle. A sphere 40, which comprises a through, radially extending spherical channel 41, is arranged in each of the spherical receptacles 39. From the right-hand front side of the spherical receptacles 39 in FIG. 2 the respective cross-cut 27, 28, 29, 30 runs co-axially as a narrower region of the stepped bore.

The diameter of the spherical receptacles 39 corresponds to the external diameter of the spheres 40, while the length of the spherical receptacles 39 is somewhat less. The diameter of the spheres 40 is somewhat larger than the diameter of the water outlet openings 19, 20, 21, 22, so that the spheres 40 can penetrate from inside to some extent into these water outlet openings 19, 20, 21, 22 and be fixed in situ there. The diameter of the spherical channels 41 corresponds roughly to the diameter of the cross-ducts 27, 28, 29, 30.

Between the spheres 40 and the inner annular front surfaces of the spherical receptacles 39 there is arranged in each case an elastic O-ring 42, the pre-tensioning of which forces the respective sphere 40 to the left into the corresponding water outlet opening 19, 20, 21, 22.

In addition each spherical channel 41 has in its right-hand region shown in FIG. 2 a cross-sectional enlargement, which serves as a centring receptacle 44 for a corresponding centring cylinder 43.

The centring cylinders 43 concentrically adjoin the corresponding cross-ducts 27, 28, 29, 30 as shown on the left-hand side of FIG. 2. The internal contours of the cross-ducts 27, 28, 29, 30 transform in each case into the internal contours of the centring cylinders 43. The external cross-sections of the centring cylinders 43 are somewhat smaller than the internal cross-sections of the centring receptacles 44 of the spheres 40. The centring cylinders 43 are just high enough so that the spheres 40, once they have been forced into the corresponding water outlet openings 19, 20, 21, 22, maintain an interspacing to the respective centring cylinders 43.

By means of the centring cylinders 43 the spheres 40 are centred in the respective spherical receptacles 39 when they are displaced to the right in FIG. 2 against the elastic force of the O-rings 42. The axes of the spherical channels 41 then run co-axially to the axes of the corresponding spherical receptacles 39. If the spheres 40 are forced by the elastic force of the O-rings 42 to the left into the water outlet openings 19, 20, 21, 22, they slip from the centring cylinders 43 and can then rotate substantially freely.

In order to mount the water outlet pipe 3, the O-rings 42 and the spheres 40 are first of all introduced into the respective spherical receptacles 39. Following this the cylindrical insert 17 is inserted into the outer tube 16 from below (see FIG. 2). At the same time the spheres 40 are displaced radially in the cylindrical insert 17 inwardly to the respective centring cylinders 43, against the elastic force of the respective O-rings 42. As soon as the cylindrical insert 17 has reached its end position in the outer pipe 16, in other words as soon as the spheres 40 can penetrate from inside into the respective water outlet openings 19, 20, 21, 22, the tension of the O-rings 42 is released and they thereby displace the spheres 40 shown in FIG. 2 radially outwardly to the left. The spheres 40 engage in the water outlet openings 19, 20, 21, 22 and at the same time slide from the centring cylinders 43, so that they are no longer fixed by the latter. The spheres 40 may then be rotated for example with an Allen key or a pin or the like so as to align the water jets.

The cylindrical insert 17 is preferably made of plastics material, though it may also be made of another material, for example of metal.

The water outlet pipes 3 and the socket chambers 8 may also have a polygonal or oval cross-section instead of a circular cross-section.

The water channels 10, 11, 12, 13, instead of being connected in each case to an individual water outlet opening 19, 20, 21, 22, may also be connected to a group of water outlet openings, in which case the respective water channel then terminates, viewed in the flow direction, immediately behind the last water outlet opening of the group.

Instead of the O-rings 42 more parts, for example washers, can be used with other loads.

The cylindrical insert and the water outlet pipe may also have an oval or polygonal, in particular rectangular or hexagonal, cross-section. Instead of the spheres 40 cylindrical pieces may also be provided, in which case the direction of the water jet can then be adjusted differently.

1. A sanitary water outlet fitting comprising at least one water outlet pipe with a water channel extending therein, and having a water outlet device with a water outlet opening,
wherein
a water outlet pipe comprises at least one further separate water channel with at least one further water outlet device which is axially off-set in relation to the first water outlet opening, in which each water channel is connected via a cross-duct to the water outlet device corresponding to it.

2. The sanitary water outlet fitting of claim 1, wherein the cross-ducts run rectilinearly to the jacket surface of the water outlet pipe.

3. The sanitary water outlet fitting of claim 1, wherein the order in which the water channels, viewed from the water outlet opening, are arranged behind one another corresponds to the order of the water outlet openings corresponding to them in each case, viewed from the fitting housing.

4. The sanitary water outlet fitting of claim 1, wherein the water channels, viewed from the fitting housing, terminate in each case immediately behind the cross-ducts corresponding to them.

5. The sanitary water outlet fitting of claim 1, wherein the water outlet pipe has a constant cross-section over its whole length.

6. The sanitary water outlet fitting of claim 1, wherein the water channels have in each case a constant cross-section over their whole length.

7. The sanitary water outlet fitting of claim 1, wherein the water channels run substantially parallel.

8. The sanitary water outlet fitting of claim 1, wherein the water channels comprise in each case a water-conveying main region of a large cross-section and a water-conveying connection region connected to the latter, for the corresponding water outlet devices, the said connection region extending beyond the axial plane containing the corresponding cross-ducts.

9. The sanitary water outlet fitting of claim 1 wherein the main regions of the water channels are arranged substantially along the edge of the water outlet pipe.

10. The sanitary water outlet fitting of claim 1, wherein the water outlet openings are arranged along a straight line that runs substantially parallel to the axis of the water outlet pipe.

11. The sanitary water outlet fitting of claim 1, wherein the water outlet pipe comprises an outer pipe and a cylindrical insert which can be inserted into the latter, in which the water channels run.

12. The sanitary water outlet fitting of claim 11, wherein the water outlet devices in the cylindrical insert include in each case a receptacle, connected to the respective water channel, for a body displaceable inwardly and substantially perpendicularly to the jacket surface of the cylindrical insert and the body comprises a through channel, wherein the receptacle comprises a pre-tensioning unit, which forces the body outwardly.

13. The sanitary water outlet fitting of claim 12, wherein a centring cylinder is provided for the body.

14. The sanitary water outlet fitting of claim 1, wherein a plurality of adjacent water outlet openings are associated at least with one water channel.

15. The sanitary water outlet fitting of claim 1, wherein a group of water outlet openings arranged after one another as viewed in the flow direction are associated at least with one water channel, and the water channel terminates directly behind the last water outlet opening of the group, viewed in the flow direction.

16. The sanitary water outlet fitting according to one of the preceding claims, characterised in that the ends of the water channels project from the end of the water outlet pipe facing towards the fitting housing, wherein their axes are oriented parallel to the axis of the water outlet pipe, and the fitting housing comprises a socket chamber with socket receptacles complementary to the ends of the water channels.

17. The sanitary water outlet fitting according to claim 16, wherein the water outlet pipe in the socket chamber is cast from hardened material.

18. The sanitary outlet fitting of claim 5, wherein the cross-section of the water outlet pipe is circular.

19. The sanitary water outlet fitting of claim 12, wherein the pre-tensioning unit is an elastic O-ring, elastic disc, or the like.
